(19) United States
(12) Patent Application Publication
(10) Pub. No.: US 2024/0339278 A1
(43) Pub. Date: Oct. 10, 2024

(54) OVERCURRENT PROTECTION DEVICE BASED ON THERMO MAGNETICALLY-SHIFTABLE MATERIAL

(71) Applicants: CENTRE NATIONAL DE LA RECHERCHE SCIENTIFIQUE, PARIS (FR); INSA LYON, VILLEURBANNE (FR); UNIVERSITE CLAUDE BERNARD LYON 1, Villeurbanne Cedex (FR); ÉCOLE CENTRALE DE LYON, ECULLY (FR); TOHOKU UNIVERSITY, Miyagi (JP)

(72) Inventors: Mickaël LALLART, VILLEURBANNE (FR); Gaël SEBALD, Miyagi (JP); Hiroyuki MIKI, Miyagi (JP)

(73) Assignees: CENTRE NATIONAL DE LA RECHERCHE SCIENTIFIQUE, PARIS (FR); INSA LYON, VILLEURBANNE (FR); UNIVERSITE CLAUDE BERNARD LYON 1, Villeurbanne Cedex (FR); ÉCOLE CENTRALE DE LYON, Écully (FR); TOHOKU UNIVERSITY, Miyagi (JP)

(21) Appl. No.: 18/292,557

(22) PCT Filed: Jun. 29, 2022
(86) PCT No.: PCT/EP2022/067948

§ 371 Date: Jan. 26, 2024

(30) Foreign Application Priority Data
Jul. 30, 2021 (EP) 21306074.2

(51) Int. Cl. H01H 71/14; H01H 71/24; H01H 71/32; H01H 71/40

(52) U.S. Cl. CPC H01H 71/145; H01H 71/142; H01H 71/2409; H01H 71/2454; H01H 71/323; H01H 71/402

(57) ABSTRACT

An overcurrent protection device for a circuit to be monitored, having at least one trigger unit, which is configured for an interruption of the circuit in at least one trigger situation and which includes at least one conductor section which is configured for a conduction of a current to be monitored, at least one conductive trigger element, which includes at least one thermo magnetically-shiftable material configured for a magnetic property change in dependence on the temperature induced by a current that flows through the conductor section, a conductive magnetic module, a conductive magnetic core, the conductive magnetic module being movable between a first position faced against the conductive trigger element permitting the conduction of the current through the conductor section and a second position faced against said conductive magnetic core breaking the conduction of the current through the conductor section.

### FIELD

The present invention relates to an overcurrent protection for a circuit to be monitored.

### BACKGROUND

Overcurrent protection switches are known from the prior art which comprise an electromagnetic short-circuit current trigger unit and a thermal overcurrent protection trigger unit.

Electromagnetic short-circuit current trigger units frequently have a trigger armature operating according to the reluctance principle. It uses a magnetic coil, so that when a high current flows through the coil, a magnetic field is established, creating an electromagnet that pushes the contact away and opens the circuit. The magnetic protection has a very fast reaction time, in response to a severe default (several 10's of rated current).

Furthermore, overcurrent protection trigger units often comprise bimetal trigger units. This piece gets deformed with heat induced by current through Joule effect. The small deformation of the bimetal eventually lifts the holder above, opening the circuit. Such protection works for current slightly above rated current with a long response time, and permits a protection against moderate defaults.

As conventional circuit breakers rely, for moderate surge, on a bimetallic strip to protect circuit from moderate overcurrent, such bimetallic strips have quite significant dimensions and small deflection.

They are indeed based on difference of thermal expansion coefficient of the two metallic layers. This requires kind of amplification mechanicals make of bulky springs and pinion mechanism.

In addition, both thermal protection and possibly magnetic one are not bistable, requiring a pinion for maintaining the circuit open once the circuit is opened and the bimetallic strip cooled down.

Finally, thermal and magnetic protection use different physical effects, requiring more space for implementation and a lot of additional mechanical parts which make the triggering less accurate.

Thus, the document DE 959 475 C, relates to an electromagnetic circuit breaker in combination with a circuit breaker using a thermally sensitive low Curie point member. In the cold state, the magnet 4 swings against the force of a return spring 5 towards the fixed thermomagnetic member 2, through which the current to be monitored flows. If the current exceeds a predetermined value, the heated thermomagnetic element exceeds its transformation point (Curie point) and becomes non-magnetic. Under the force exerted by spring 5, the magnet 4 then falls off and triggers, for example, the opening of the electric circuit.

Document U.S. Pat. No. 3,702,980 relates to a thermal-magnetic circuit breaker combined with a circuit breaker using a thermomagnetic element, and describes in FIG. 4 a circuit breaker comprising the conductor 4 constituted by a monolithic steel plate which is both magnetisable and electrically conductive. The terminals 2 and 3 are mounted on the left and right side plates 1e and 1f, respectively. A magnet 7, attached to the inner side of the top plate 1c, makes direct contact with the conductor 4 with part 11. When a high current through terminals 2 and 3 exceeds a given magnitude, it instantly magnetises both conductor 4 and part 11 to identical polarities to induce repulsion between them, causing conductor 4 to move angularly towards the lower plate 1d and thus separating contacts 5 and 6. The actuator 14 is located in the bottom plate 1d and is surrounded by a coil spring 19 which normally biases the actuator 14 to project out of the housing. The plunger 14 allows the conductor 4 to be re-engaged with the part 11. When the conductor 4 is made of a thermo-magnetic steel, a large change in magnetic permeability due to a change in temperature allows a current flow of higher level than the rated current to produce a circuit interruption due to the reduced attractive force exerted by the magnet 7 on the conductor 4 since the conductor 4 is sufficiently heated by Joule heat to have a substantially reduced permeability.

The document DE 70 29 288 U describes a circuit breaker with trip according to a current threshold, comprising two attractive magnetic parts, one of which is a permanent magnet and the other made of a magnetic material with a low Curie point, one of which is mounted on the casing and the other of which is connected to a switching bridge, with a plunger 14, by means of which the switching bridge can be moved relative to the fixed contacts. A spring 7 acts on the magnetic part 6 arranged on the housing against the attractive force between the two magnetic parts 6, 10. Therefore, it appears necessary to replace bimetallic strip and to remove mechanical springs in electronic circuit breaker by a mechanism that is more compact and more accurate.

### SUMMARY

The objective of the invention is in particular to provide a generic overcurrent protection device with advantageous properties with respect to a compact design.

Furthermore, one object of the invention is in particular to achieve a high level of reliability.

Furthermore, one object of the invention is in particular to reduce a variety of parts.

The object is achieved according to the invention by an overcurrent protection device for a circuit to be monitored, having at least one trigger unit, which is configured for an interruption of the circuit in at least one trigger situation and which comprises at least one conductor section which is configured for a conduction of a current to be monitored, at least one trigger element, which comprises at least one thermo magnetically-shiftable material configured for a magnetically change in dependence on the temperature induced by a current that flows through the conductor section, a conductive magnetic module, a magnetic core, said conductive magnetic module being movable between only two stable positions, that is a first position faced against said conductive trigger element permitting the conduction of the current through the conductor section and a second position faced against said conductive magnetic core breaking the conduction of the current through the conductor section, said overcurrent protection device using neither mechanical spring return force nor gravity effect.

According to one embodiment, the thermo magnetically-shiftable material may be endowed with conductive and heating properties so that it constitutes alone a very small trigger element.

In this case, the thermo magnetically-shiftable material may be advantageously selected from the group consisting of conventional ferromagnetic alloys and more advantageously of ferromagnetic shape-memory alloy.

According to one preferred configuration, the thermo magnetically-shiftable material may have a serpentine or zigzag shape to increase the resistance and to decrease the response time compared to the tuned nominal current.

According to another preferred configuration, the thermo magnetically-shiftable material may be folded as multilayer material to increase the resistance and to decrease the response time compared to the tuned nominal current.

According to one other embodiment, the conductive trigger element may be constituted of a thermo magnetically-shiftable material endowed with conductive properties, and of a heating device.

According to one other embodiment, the conductive trigger element may be constituted of a thermo magnetically-shiftable material, of a heating device and of a conductive element.

According to one other embodiment, the conductive trigger element may be constituted of a thermomagnetic material, and of a conductive and heating element.

According to one other embodiment, the conductive magnetic module may be constituted of a permanent magnet that also conducts current.

According to one other embodiment, the conductive magnetic module may be constituted of a first magnetic element (such as permanent magnet) and of a second conductive element.

Advantageously, the conductive magnetic core may be wrapped with windings to form an electromagnet, the windings acting as an electromagnet if a high current well above rated current flows.

Advantageously, the overcurrent protection device may comprise means to topple the conductive magnetic module from the second position to the first position, and reciprocally.

Preferred embodiments of the invention are disclosed in following description and the accompanying drawing which are merely illustrative of such invention.

### BRIEF DESCRIPTION OF THE FIGURES

FIG. 1 represents an exemplary embodiment of the present invention.

FIG. 2 represents an exemplary embodiment of the present invention.

FIG. 3 represents an exemplary embodiment of the present invention.

FIG. 4 represents an exemplary embodiment of the present invention.

FIG. 5 represents an exemplary embodiment of the present invention.

FIG. 6 represents an exemplary embodiment of the present invention.

FIG. 7 represents an exemplary embodiment of the present invention. The functions are represented as follow: reference 20: hard ferromagnetic element (magnet); reference 21: conductive element; reference 30: conductive element, reference 31: thermo magnetically-shiftable property, reference 32: heating element. A single material can encompass several of these functions.

FIG. 8a shows experimental results relating to an experimental setup.

FIG. 8b shows experimental results relating to an experimental setup.

FIG. 9 shows experimental results relating to an experimental setup.

FIG. 10a shows experimental results relating to an experimental setup.

FIG. 10b shows experimental results relating to an experimental setup.

### DETAILED DESCRIPTION

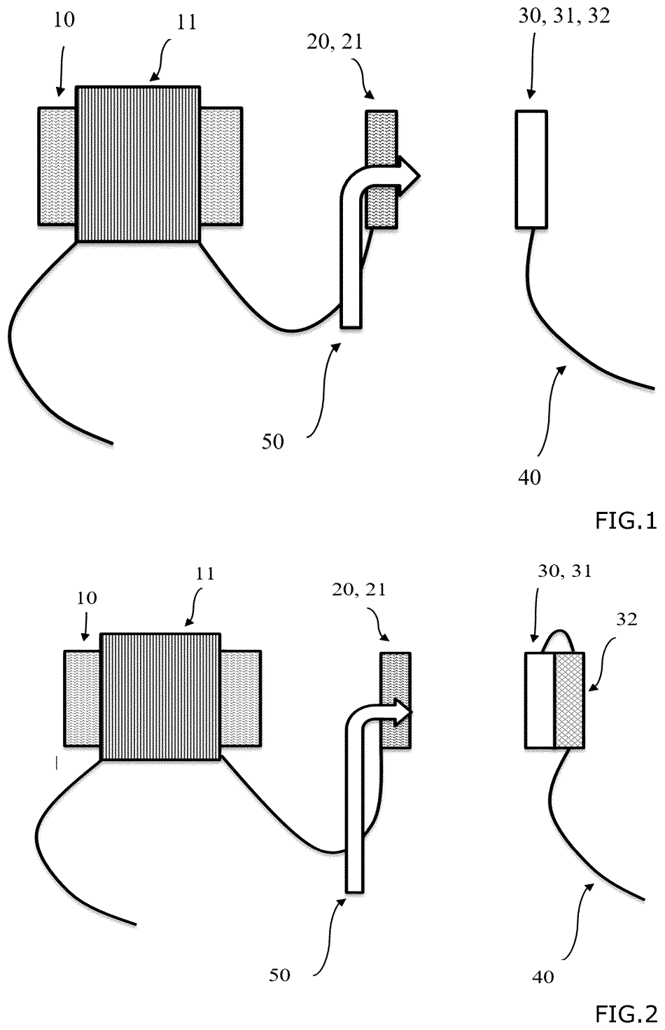

Referring to the FIGS. 1 to 7 of the drawing, there is represented an overcurrent protection device for a circuit to be monitored having a trigger unit according to a particular embodiment.

For each embodiment, the trigger unit, which is configured for an interruption of the circuit in at least one trigger situation, comprises at least one conductor section 40 which is configured for a conduction of a current to be monitored, at least one conductive trigger element 30, 31, 32, which comprises at least one thermo magnetically-shiftable material configured for a magnetically change in dependence on the temperature induced by a current that flows through the conductor section, a conductive magnetic module 20, 21, a conductive magnetic core 10.

The conductive magnetic module 20, 21, comprising especially a permanent magnet or an electromagnet, is movable between only a first position faced against said conductive trigger element 30, 31, 32 permitting the conduction of the current through the conductor section 40 and a second position faced against said conductive magnetic core 10 breaking the conduction of the current through the conductor section.

The overcurrent protection device using neither mechanical spring return force nor gravity effect.

The expression “without using mechanical spring return force” means that the overcurrent protection device does not contain any spring intended to bring back the magnetic module to a position when the magnetic module is no longer attracted to the conductive trigger element.

The expression “without using gravity effect” means that the magnetic module does not return to a position due to its weight, when the magnetic module is no longer attracted to the conductive trigger element.

Concerning the thermal protection, the principles of operations are detailed hereinafter.

During normal operation, the conductive magnetic module 20,21 is in contact with the ferromagnetic material or with the Ferromagnetic Shape Memory Alloys. Both being conductive or making the contact of a conductive element with another conductive element, this closes the electrical circuit.

As the current flowing is small, the ferromagnetic material or the Ferromagnetic Shape Memory Alloys temperature is moderate so that the material keeps its magnetic properties.

The magnetic force exerted by the electromagnet, in the case where the conductive magnetic core 10 is wrapped with windings 11, is too small to attract the magnet attached to the switching unit.

The conductive magnetic module 20,21 is thus kept in contact with the ferromagnetic material or the Ferromagnetic Shape Memory Alloys and the circuit remains closed.

To sum up, under a current below a preset current value, the conductive trigger element 30, 31, 32 shows a limited increase of temperature.

Hence, it keeps its magnetic properties and attracts the conductive magnetic module 20, 21, hence ensuring electrical contact inside of the conductor section 40 allowing current to flow.

If a moderate current slightly above rated current flows, this yields a heating of the ferromagnetic material or the Ferromagnetic Shape Memory Alloys, that partly loses its magnetic properties.

Hence, the ferromagnetic material or the Ferromagnetic Shape Memory Alloys exerts a lower force on the magnet with respect to the conductive magnetic core of the windings, that thus attracts the magnet.

The circuit is thus opened.

However, the windings itself does not intervene in the process, the current being too small to provide sufficient magnetic force.

To sum up, when a slight overcurrent occurs, the conductive trigger element 30, 31, 32 is heated (either self-heating or external heating) and loses its magnetic properties.

Hence the conductive magnetic module 20, 21 is attracted by the conductive magnetic core (10), opening the conductor section 40.

Once opened, the conductive magnetic module 20, 21 sticks to the conductive magnetic core (10), even when the conductive trigger element 30, 31, 32 cools down and regains magnetic properties.

Concerning the magnetic protection, if a high current well above rated current flows, the windings act as an electromagnet.

It attracts the magnet and thus opens the circuit.

This happens quickly, even before the ferromagnetic material or the Ferromagnetic Shape Memory Alloys heats up.

Once opened, an external operator needs to rearm the circuit by exerting an external mechanical actions to the conductive trigger element 30, 31, 32 (and potentially associated elements fixed to it) to close the circuit again, as the magnetic attraction between the conductive magnetic module 20, 21 and the conductive magnetic core 10 is higher than between the conductive trigger element 30, 31, 32 and the conductive magnetic module 20, 21, hence maintaining the circuit opened.

Advantageously, the trigger unit comprises means 50 to topple the conductive magnetic module 20, 21 from the second position to the first position.

Advantageously, the effect of the magnetic force exerted by and on module (20,21) can be tuned through mechanical interactions, for instance using spring effect or gravity.

The conductive trigger element 30, 31, 32 is at least partly constituted of a ferromagnetic material.

Ferromagnetic materials are material that possess magnetic properties but lose them as the temperature increases.

Permanent magnets (materials that can be magnetized by an external magnetic field and remain magnetized after the external field is removed) are either ferromagnetic or ferrimagnetic, as are the materials that are noticeably attracted to them. Only a few substances are ferromagnetic. The common ones are iron, cobalt, nickel and most of their alloys, and some compounds of rare earth metals such as neodymium.

Ferromagnetic materials can be divided into magnetically “soft” materials like annealed iron, which can be magnetized but do not tend to stay magnetized, and magnetically “hard” materials, which do. Permanent magnets are made from “hard” ferromagnetic materials such as alnico, and ferrimagnetic materials such as ferrite that are subjected to special processing in a strong magnetic field during manufacture to align their internal microcrystalline structure, making them very hard to demagnetize. To demagnetize a saturated magnet, a certain magnetic field must be applied, and this threshold depends on coercivity of the respective material. “Hard” materials have high coercivity, whereas “soft” materials have low coercivity. The overall strength of a magnet is measured by its magnetic moment or, alternatively, the total magnetic flux it produces. The local strength of magnetism in a material is measured by its magnetization.

Ferromagnetic materials are preferred material in so far as they allow a temperature-dependent response to an applied magnetic field. More precisely, they feature at low temperature a moderate to high permeability, making them sensitive to an external magnetic field (i.e., they are attracted by a magnet for example), but following a temperature-induced second-order phase transition, they lose this magnetic behavior above a given temperature (Curie temperature), so that they are no longer attracted by a magnet for instance. An example of ferromagnetic material is compound based on Iron and Nickel materials.

Ferromagnetic Shape Memory Alloys are preferred material in so far as they combine the ferromagnetic behavior of the austenite phase with structural phase transition.

As the high-temperature phase is not magnetic (i.e. martensitic phase), this yields an even sharper loss of magnetic properties compared to conventional ferromagnetic materials (i.e., without structural phase transition). At low temperature they can be attracted by magnets, but not at high temperatures (above transition given by Curie temperature).

Magnetic shape memory alloys (MSMAS), also called ferromagnetic shape memory alloys (FSMA) or MultiPhysic Memory Alloys (MPMAS), are particular shape memory alloys which produce forces and deformations in response to a magnetic field. The thermal shape memory effect has been obtained in these materials, too.

MSM alloys are ferromagnetic materials that can produce motion and forces under moderate magnetic fields. Typically, MSMAs are alloys of Nickel, Manganese and Gallium (Ni—Mn—Ga).

The large magnetically induced strain, as well as the short response times make the MSM technology very attractive for the design of innovative actuators.

MSM alloys change their magnetic properties depending on the deformation. This companion effect, which co-exist with the thermal response, can be useful for the design of displacement, speed or force sensors and mechanical energy harvesters.

The magnetic shape memory effect occurs in the low temperature austenite phase of the alloy, where the elementary cells composing the alloy have tetragonal geometry. If the temperature is increased beyond the martensite-austenite transformation temperature, the alloy goes to the martensitic phase where the elementary cells have cubic geometry. With such geometry the magnetic effect is lost.

The transition from austenite to martensite (and conversely) produces force and deformation. Therefore, MSM alloys can be also activated thermally, like thermal shape memory alloys (see, for instance, Nickel-Titanium (Ni—Ti) alloys).

The mechanism responsible for the large strain of MSM alloys is the so-called magnetically induced reorientation (MIR).

Like other ferromagnetic materials, MSM alloys exhibit a macroscopic magnetization when subjected to an external magnetic field, emerging from the alignment of elementary magnetizations along the field direction. However, differently from standard ferromagnetic materials, the alignment is obtained by the geometric rotation of the elementary cells composing the alloy, and not by rotation of the magnetization vectors within the cells (like in magnetostriction).

The main properties of the MSM effect for commercially available elements are summarized in [9] (where other aspects of the technology and of the related applications are described), yielding the following typical characteristics (which can however change from one alloy to another):
Strain up to 6%
Max. generated stress up to 3 MPa
Minimum magnetic field for maximum strain: 500 kA/m
Full strain (6%) up to 2 MPa load
Workoutput per unit volume of about 150 KJ/m\hat{ }3
Energetic efficiency (conversion between input magnetic energy and output mechanical work) about 90%
Internal friction stress of around 0.5 MPa
Magnetic and thermal activation
Operating temperatures between −40 and 60° C.
Change in magnetic permeability and electric resistivity during deformation

Standard alloys are Nickel-Manganese-Gallium (Ni—Mn—Ga) alloys, which are investigated since the first relevant MSM effect has been published in 1996. [1] Other alloys under investigation are Iron-Palladium (Fe—Pd) alloys, Nickel-Iron-Gallium (Ni—Fe—Ga) alloys, and several derivates of the basic Ni—Mn—Ga alloy which further contain Iron (Fe), Cobalt (Co) or Copper (Cu). The main motivation behind the continuous development and testing of new alloys is to achieve improved thermo-magneto-mechanical properties, such as a lower internal friction, a higher transformation temperature and a higher Curie temperature, which would allow the use of MSM alloys in several applications. In fact, the actual temperature range of standard alloys is up to 50° C. Recently, an 80° C. alloy has been presented.

The FIG. 1 depicts a particular compact embodiment with a minimum of pieces in which the thermo magnetically-shiftable material is moreover a conductive and heating material so that it constitutes alone the conductive trigger element 30, 31, 32.

Advantageously, the ferromagnetic material or the ferromagnetic materials or the Ferromagnetic Shape Memory Alloys have a serpentine-shape or are folded as multilayer materials.

These special shapes permit to increase the resistance and to decrease the response time compared to the tuned nominal current.

The conductive magnetic module 20, 21 is constituted of a magnetic material such as Nickel-Iron or Neodymium compounds.

The FIG. 2 depicts a particular embodiment in which the conductive trigger element 30, 31, 32 is constituted of a thermo magnetically-shiftable material 30, 31 which is conductive and of a heating device 32.

The heating device is advantageously a heating resistor, a cartridge or a thermoelectric material such as bismuth telluride material.

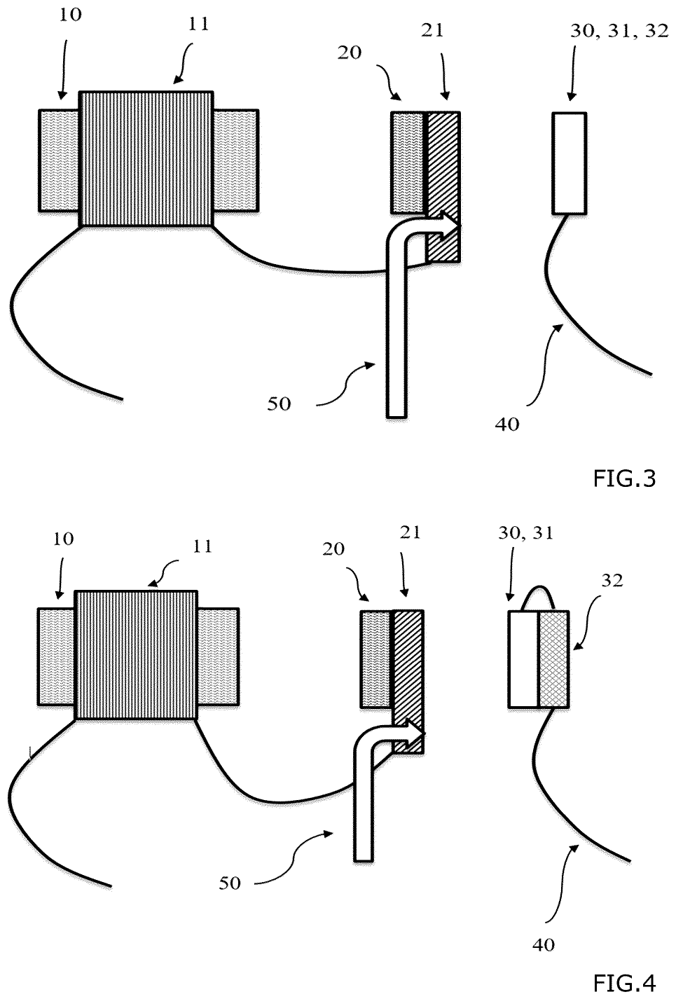

The FIG. 3 depicts a particular embodiment in which the thermo magnetically-shiftable material is moreover a conductive and heating material so that it constitutes the conductive trigger element 30, 31, 32 as in FIG. 1 and in which the conductive magnetic module 20, 21 is constituted of a first magnetic element 20 and of a second conductive element 21.

The FIG. 4 depicts a particular embodiment in which the conductive trigger element 30, 31, 32 is constituted of a thermo magnetically-shiftable material 30, 31 which is conductive and of a heating device 32 according to the FIG. 2.

The conductive magnetic module 20, 21 is constituted of a first magnetic element 20 and of a second conductive element 21 according to the FIG. 3.

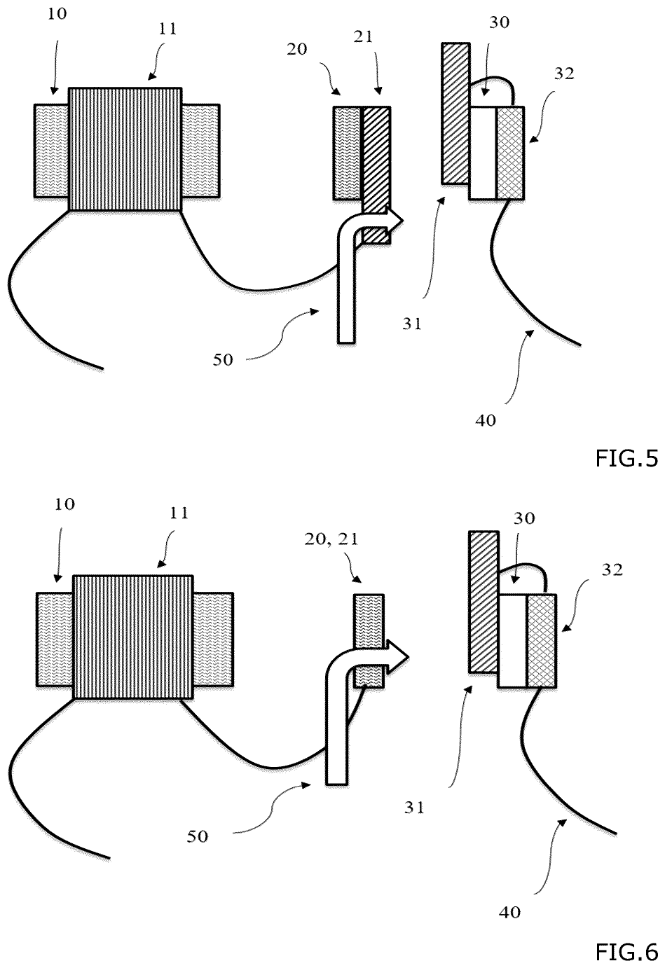

The FIG. 5 depicts a particular embodiment in which the conductive magnetic module 20, 21 is constituted of a first magnetic element 20 and of a second conductive element 21 according to the FIG. 3.

The conductive trigger element 30, 31, 32 is constituted of the thermo magnetically-shiftable material 31, of a heating device 32 and of an conductive element 30.

The FIG. 6 depicts a particular embodiment in which the conductive trigger element 30, 31, 32 is constituted of the thermo magnetically-shiftable material 30, of a heating device 32 and of a conductive element 30 according to the FIG. 5.

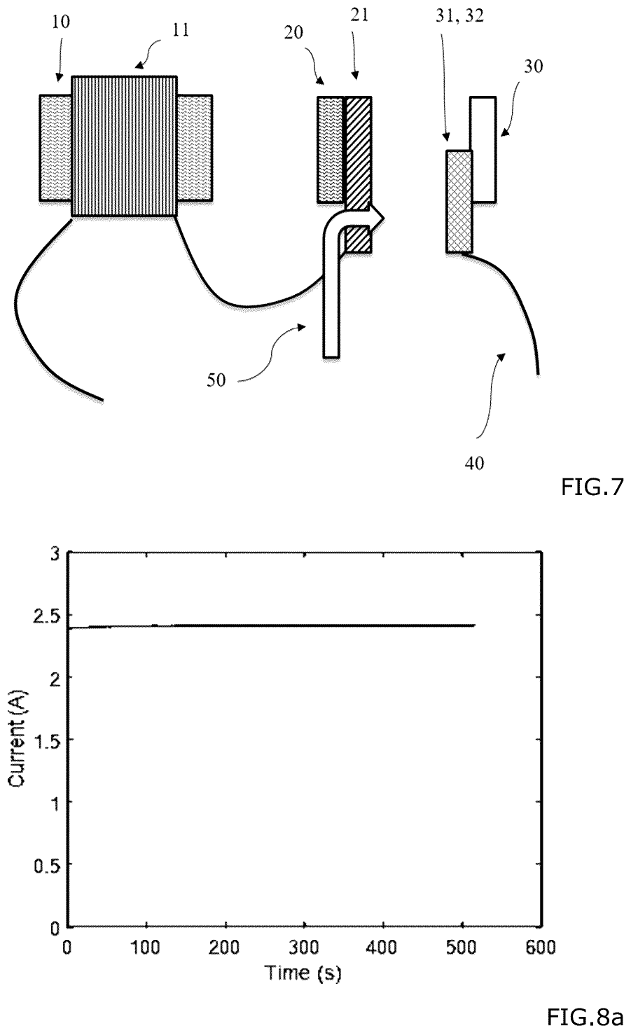

The FIG. 7 depicts a particular embodiment in which the conductive trigger element 30, 31, 32 is constituted of a thermomagnetic material 30, and of a conductive and heating element 31, 32.

Advantageously, for all the preceding embodiments, the conductive magnetic core 10 can be wrapped with windings 11 to form an electromagnet.

An electrical breaker solution has been developed to combine thermal protection (above 2.5 A) and electromagnetic protection (from 7 A) by using the same device.

This overcurrent protection device is precisely constituted of:

An electromagnet with a coil of 30 turns of 22 AWG wire 10, 11 was fabricated. The conductive magnetic core 10 (diameter of 10 mm and 40 mm in length) is terminated by a cone for magnetic flux concentration of height 6 mm and final diameter of 6 mm. It is made of soft iron with high magnetic permeability.

A rotating beam made of soft iron (width of 5 mm, length of 32 mm and thickness of 1 mm) was fabricated. It is covered at 26 mm from the rotation axis with 4 neodymium magnets 20 of 5 mm diameter and 2 mm thickness, (2 on each side of the beam). On the top of the beam is bonded a curved brass sheet 21.

A 0.1 Ohm electrical resistance of flat shape (9×14×2 mm3) 32, on which is bonded a small bar of thermomagnetic material 31 (length 5 mm, width of 2 mm and thickness of 1 mm). On top of this part is also bonded a partly folded brass sheet 30, ensuring the electrical contact with the second brass part. A thermocouple is inserted in close contact with the thermomagnetic material 31.

The thermomagnetic material is a bar of PHYTHERM 45 from Aperam (FeNi30 alloy).

The distance between the electromagnet and the magnets of the rotating beam is set to 5 mm when the breaker is open.

Turning now to the experimental setup, a current source (model IPS1820HD, RS PRO) is used to test the device.

After setting the current value, it is applied through the electrical breaker until the protection opens the circuit.

The temperature of the thermomagnetic material is monitored using a K-type thermocouple.

The current flowing through the breaker is monitored using a shunt resistor of 0.1 Ohm.

No load is connected to the breaker (i.e., the electrical generator is solely plugged to the breaker and shunt).

Temperature, current and voltage on the breaker are acquired using a Dewesoft KRYPTONi-8xLV and a Dewesoft KRYPTONi-8xTH Data Acquisition System.

The sampling frequency of the voltage and current measurements was 20 kHz whereas it was of 100 Hz for temperature measurement.

Each tested current was applied two successive times in order to check the reproducibility of the breaker function.

From the simultaneous voltage and current measurements, the total resistance of the electrical breaker was found to range between 0.3 Ohm and 0.4 Ohm, composed of 0.1 Ohm for the heating resistor, and 0.2˜0.3 Ohm for the wires and contact resistance between the brass parts.

It should be noted that a larger diameter of wires and an optimization of the contact resistance could further reduce the breaker resistance.

It should be noted also that this proof of concept corresponds to a partial electrical breaker development, and does not include the contact optimization or the control of electrical arcs at the opening.

Further developments could improve the process of opening the contact.

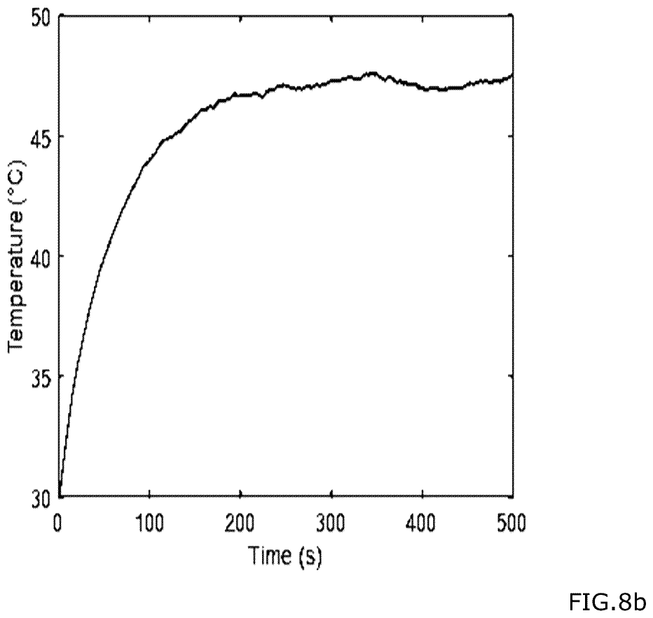

FIGS. 8a and 8b show the case of a current lower than the threshold.

The temperature of the thermomagnetic element reaches a plateau about 47° C., below the transition temperature and thus keeping its ferromagnetic properties.

As detailed in FIGS. 8a and 8b, the breaker remained closed for currents below 2.5 A, meaning that in operation below the threshold current, the voltage drops between the breaker terminals ranges between 0V and 1V.

For a current of 2.5 A or below, it was observed that the breaker remained closed even after 500 seconds.

Due to the current, the temperature of the thermomagnetic element increased and stabilized to a value far below the phase transition of the material.

The record of the temperature for 2.4 A is shown in FIGS. 7a and 7b.

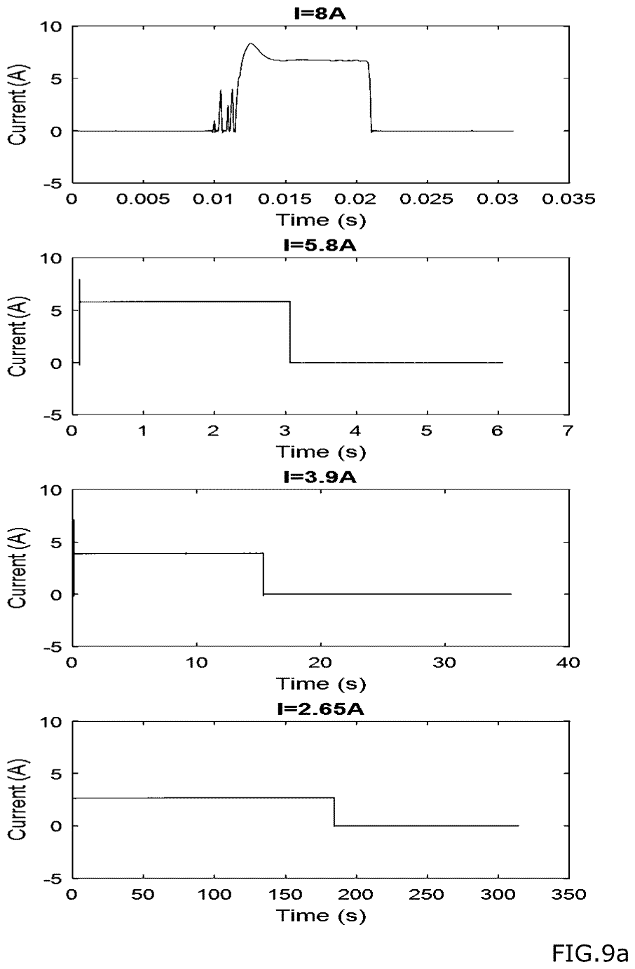

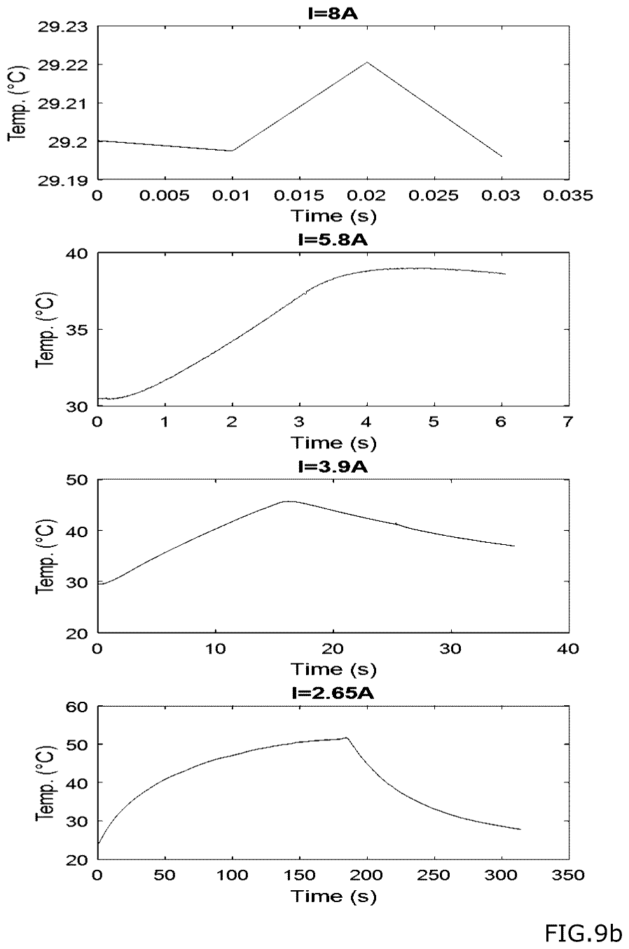

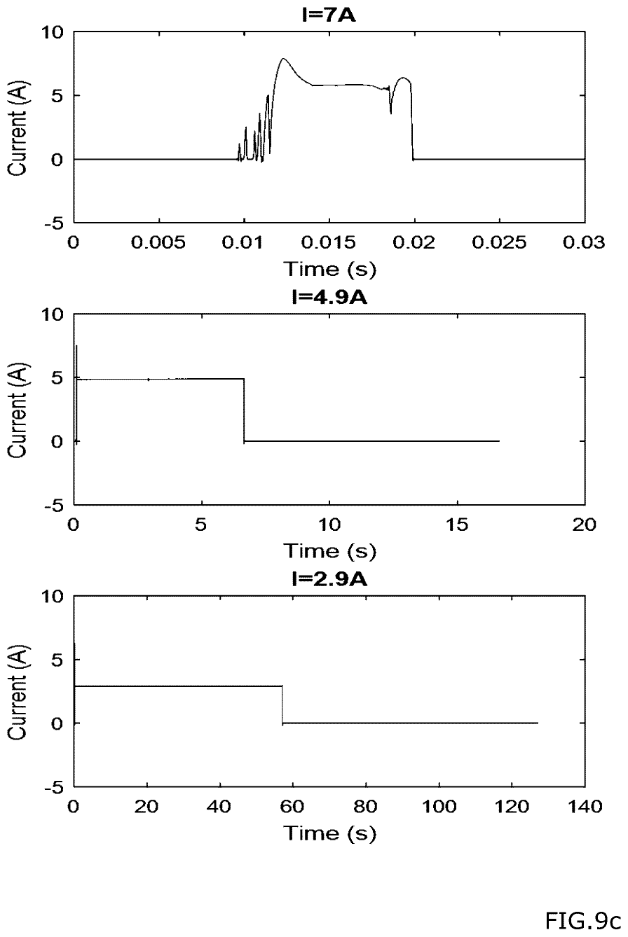

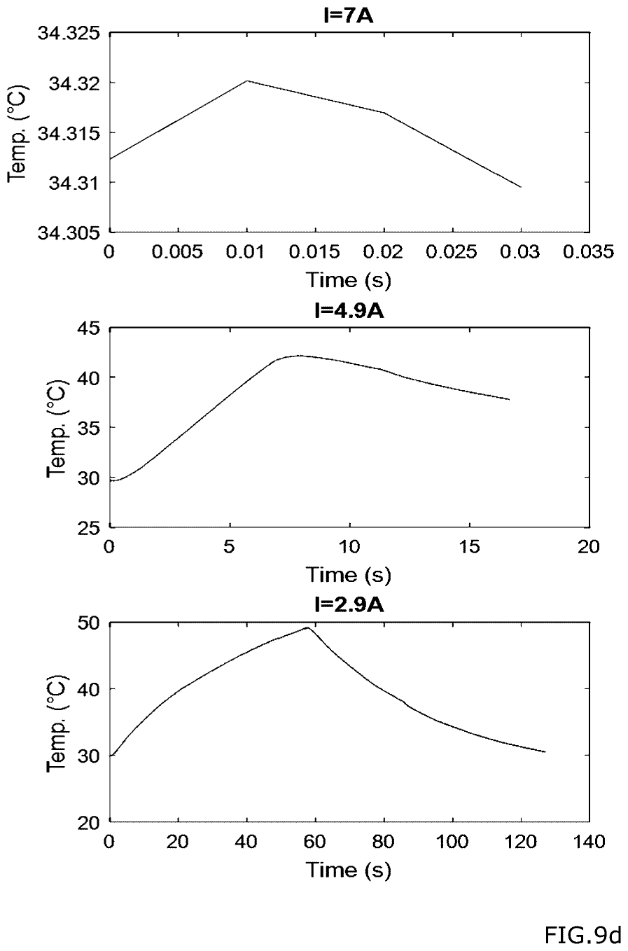

FIG. 9 shows current and temperatures measurement for different DC current applied to the breaker.

The two first results correspond to a fast opening of the breaker thanks to the electromagnetic system (current much larger than rated current).

For the 5 other tested currents, the breaker opened thanks to the thermal protection, with increasing time to open when lowering the applied current.

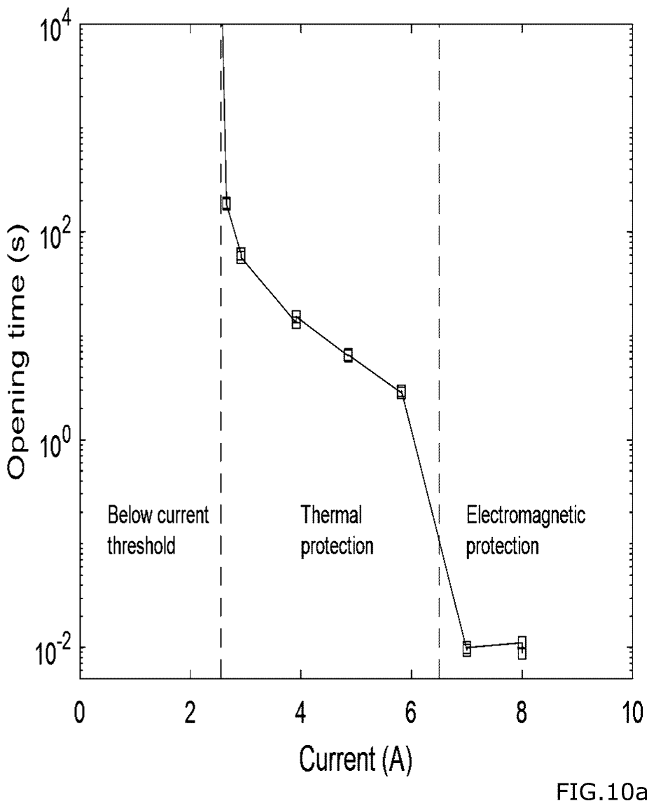

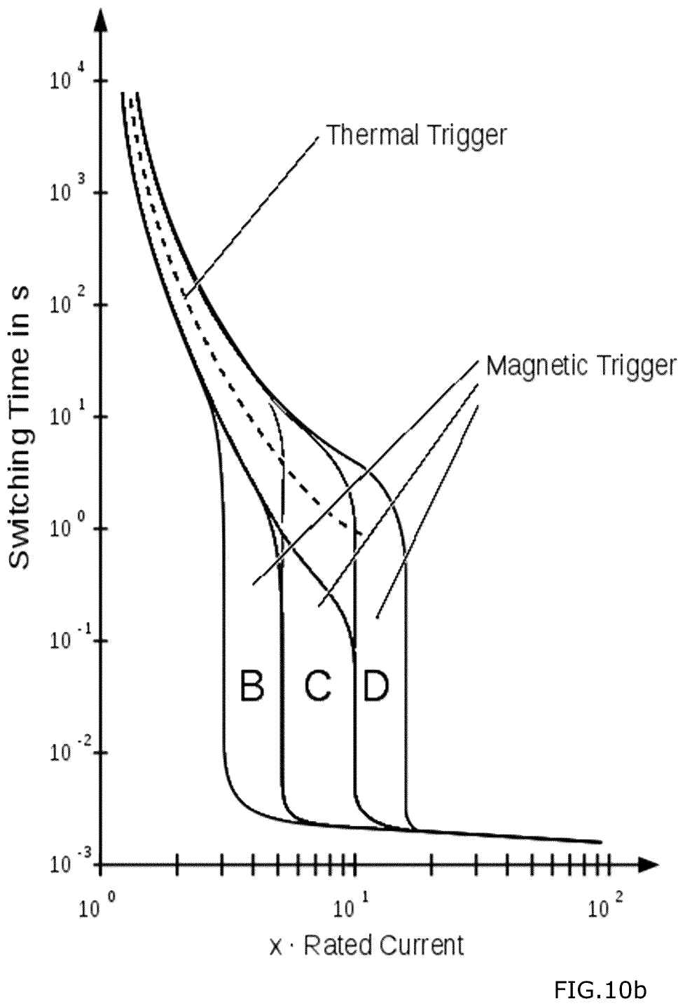

FIG. 10a shows the time to opening versus applied current. The solid line is guide to the eyes. The vertical line for currents below 2.65 A are drawn to emphasize the threshold current.

FIG. 10a shows the typical switching time vs. current for conventional electrical breaker.

From 2.65 A and above it was observed an opening of the circuit after a given time, which depends on the applied current.

The records for all tested currents are shown in FIG. 9. For I=8 A and I=7 A, the opening time was very short (<20 ms) corresponding to the electromagnetic protection.

The temperature was found to be constant during the test. For currents between 2.65 A and 5.8 A, the thermal protection led to the opening of the circuit. As expected, the highest currents led to the shortest opening times (from 3 s at I=5.8 A to 190 s at I=2.65 A). It was observed also that temperature of the thermomagnetic element at the time of the opening depends also on the current.

For these intermediate currents, the electromagnetic force also attracts the magnets, so that a partial loss of ferromagnetism at temperature below Curie temperature is enough to induce the breaker opening.

This temperature ranges from 38° C. at I=5.8 A to 51° C. at I=2.65 A.

Finally, the opening time is plotted versus applied current in FIG. 10a, showing very good match with conventional breaker response as depicted in FIG. 10b.

Each measurement was done twice, and all the data points are included in the presented graph. In the figure was added the three working zones: below the current threshold of 2.65 A, the breaker remained closed.

For intermediate current (between 2.65 A and 5.8 A), the thermal protection induced an opening of the breaker, with an exponential decrease of opening time for increasing currents.

For larger currents, the electromagnetic protection is responsible for a sharp decrease in the opening time.

This experimental setup validates the possibility of a thermal and magnetic protection based on a thermomagnetic material.

As it is based on a magnetic force, it was successfully combined with the electromagnetic protection, using the same magnetic core.

The geometry and characteristics (e.g., rated current) can be easily adjusted:
for example by increasing the distance between the conductive magnetic core and the rotating beam, or by adjusting the number of turns of the coil (a rotary spring for fine tuning may be also added),
for modifying the three regimes thresholds.

In the case of an increasing distance, the electromagnetic protection will start at higher currents, whereas the thermal protection threshold current will also increase. For adjusting the thermal protection threshold, it is also possible to:
modify the thermomagnetic alloy composition (for having larger or smaller Curie temperature) or
modify the thermal insulation around it. For example, in the current proof of concept, the thermomagnetic material was bonded on an ABS part.

Using an aluminum part would decrease the temperature rise and increase the threshold current of the thermal protection.

On the opposite, adding a thermally insulating material would lead to higher temperature rise for a given current, which in turns would lower the current threshold.

Similarly, the distance between the magnets and the ferromagnetic material when the breaker is closed is another possibility.

Hence, the proposition to replace the conventional thermal protection (bimetallic strip) by a thermal-based magnetic effect, allows not only a reduction of space of the thermal protection mechanism (spring and pinion just replaced by a moving magnet), but also sharing same physical roots as the magnetic protection. Therefore, this permits more compact electronic breakers.

In addition to the above description regarding the difference and advantages with respect to conventional similar devices (same functions in a much more compact size, possibly adapted to embedded devices), the two following points can be noted.

Temperature-dependent magnetic material can be made from very cheap materials (e.g., ferromagnetic materials).

In other word, the overcurrent protection device according to the invention offer a similar magnetic protection as conventional breaker.

Advantageously, the thermal protection is more integrated than bimetal because no springs and bulky mechanical parts is needed.

Magnetic and thermal protections are based moreover on the same material and effects.

Open circuit is maintained moreover thanks to magnetic interaction, so that still no bulky mechanical part needed.

Thus the overcurrent protection device according to the invention constitutes a much more integrable solution for small size circuits.

1-12. (canceled)

13. An overcurrent protection device for a circuit to be monitored, comprising at least one trigger unit, which is configured for an interruption of the circuit in at least one trigger situation and which comprises at least one conductor section which is configured for a conduction of a current to be monitored, at least one conductive trigger element, which comprises at least one thermo magnetically-shiftable material configured for a magnetically change in dependence on the temperature induced by a current that flows through the conductor section, a conductive magnetic module, a conductive magnetic core, said conductive magnetic module being movable between only two positions, that is a first position faced against said conductive trigger element permitting the conduction of the current through the conductor section and a second position faced against said conductive magnetic core breaking the conduction of the current through the conductor section, as a result of a magnetic force, said overcurrent protection device using neither mechanical spring return force nor gravity effect.

14. The overcurrent protection device as claimed in claim 13, wherein the thermo magnetically-shiftable material is endowed with conductive and heating properties so that it constitutes alone a very small conductive trigger element.

15. The overcurrent protection device as claimed in claim 14, wherein the thermo magnetically-shiftable material is selected from the group consisting of ferromagnetic material or ferromagnetic shape-memory alloy.

16. The overcurrent protection device as claimed in claim 14, wherein the thermo magnetically-shiftable material has a serpentine or zigzag shape to increase the resistance and to decrease the response time compared to the tuned nominal current.

17. The overcurrent protection device as claimed in claim 14, wherein the thermo magnetically-shiftable material is folded as multilayer material to increase the resistance and to decrease the response time compared to the tuned nominal current.

18. The overcurrent protection device as claimed in claim 13, wherein the conductive trigger element is constituted of a thermo magnetically-shiftable material which is endowed with conductive properties and of a heating device.

19. The overcurrent protection device as claimed in claim 13, wherein the conductive trigger element is constituted of a thermo magnetically-shiftable material, of a heating device and of a conductive element.

20. The overcurrent protection device as claimed in claim 13, wherein the conductive trigger element is constituted of a thermomagnetic material, and of a conductive and heating element.

21. The overcurrent protection device as claimed in claim 13, wherein the conductive magnetic module is constituted of a material allowing magnetic force towards magnetic core or trigger element such as conductive permanent magnet or electromagnet.

22. The overcurrent protection device as claimed in claim 13, wherein the conductive magnetic module is constituted of a first magnetic element and of a second conductive element.

23. The overcurrent protection device as claimed in claim 13, wherein the conductive magnetic core is wrapped with windings to form an electromagnet, the windings acting as an electromagnet if a high current well above rated current flows.

24. The overcurrent protection device as claimed in claim 13, further comprising means to topple the conductive magnetic module from the second position to the first position, and reciprocally.
